(19) United States
(12) Patent Application Publication
(10) Pub. No.: US 2026/0336837 A1
(43) Pub. Date: Oct. 29, 2026

(54) HINGED ASSEMBLY FOR THERMAL PROTECTION SYSTEM

(71) Applicant: Blue Origin Manufacturing, LLC, Huntsville, AL (US)

(72) Inventors: Mohammad Rouhi, Issaquah, WA (US); Bryan Bravo, Seattle, WA (US); Alfonso Mares, Seattle, WA (US); Noah L. Newton-Gladstein, Seattle, WA (US); Laura A. Ballou, Seattle, WA (US); Peter Michael Michalakos, Arlington Heights, IL (US)

(21) Appl. No.: 19/192,154

(22) Filed: Apr. 28, 2025

(51) Int. Cl. B64G 1/58; B64G 1/62

(52) U.S. Cl. CPC B64G 1/58; B64G 1/62

(57) ABSTRACT

A thermal protection system (TPS) that uses a hinged assembly is presented. The system allows for thermal growth or shrinkage of TPS assembly parts. Thus, thermally-induced loads are not necessarily transferred between TPS outer mold line components and sub-components such as stand-offs and substrate (e.g., vehicle) structures. The hinged assembly includes legs as standoffs that are hinged or pinned on both ends of the leg's connections to a panel and the underlying structure (e.g., the vehicle). Configurations of such a TPS provide a way of using standoffs to connect TPS panels to the underlying structure while providing the standoffs with a rotational degree of freedom so that thermal stresses are avoided.

### BACKGROUND

Thermal Protection Systems (TPS) are essential for spacecraft and rockets, shielding them from the extreme temperatures experienced during high-speed atmospheric entry and re-entry. TPS materials are specifically engineered to handle the intense heat generated by friction with atmospheric particles, which can reach thousands of degrees Fahrenheit. A TPS may comprise various heat-resistant materials that absorb, reflect, or dissipate heat, preventing it from reaching and damaging the internal components of the vehicle. Some TPS designs use ablative materials that gradually erode, carrying heat away from the structure, while others rely on insulating tiles that retain stability under extreme temperatures.

One well-known type of TPS, used on the Space Shuttle, involved individual silica-based tiles that provided both heat resistance and insulation. These tiles, and other materials like carbon composites or ceramic coatings, are effective but require precise engineering to fit together seamlessly. However, challenges remain, especially with thermal expansion. As TPS tiles heat up, they expand, which can create stress points if adjacent tiles don't expand at the same rate or if there isn't enough flexibility to accommodate this movement. Continuous improvements are necessary to ensure that these materials can handle repeated thermal cycles without issues like cracking, detachment, or uneven expansion, which could compromise the protective barrier.

### SUMMARY

A system for a thermal protection system (TPS) that uses a hinged support assembly allows for thermal growth or shrinkage of TPS tiles or panels. Thus, thermally-induced loads are not necessarily transferred between TPS outer mold line components and sub-components such as stand-offs and substrate structures. In some examples, the hinged support assembly involves tripod-type legs as standoffs that are hinged or pinned on one or both ends of the leg's connections to the panel and the underlying structure. Configurations of such a TPS provide a way of using standoffs to connect TPS panels to the underlying structure and providing the standoffs with a rotational degree of freedom so that thermal stresses are avoided.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a top view of a thermal protection system (TPS) panel, according to some embodiments.

FIG. 2 is a side view of a TPS panel and an underlying support system during thermal expansion of the TPS panel, according to some embodiments.

FIG. 3 is a side view of a TPS panel and an underlying support system during thermal expansion of the TPS panel and stand-offs of the support system, according to some embodiments.

FIG. 4 is a close-up side view of a support system for a TPS panel, according to some embodiments.

FIG. 5 is a top view of a TPS panel and an underlying support system, according to some embodiments.

FIG. 6 is a top view of a group of TPS panels and an underlying support system for the TPS panels, according to some embodiments.

FIG. 7 is a perspective view of a support system for TPS panels, according to some embodiments.

FIG. 8 is a close-up side view of a support system for a TPS panel, according to some embodiments.

FIG. 9 is a close-up perspective view of a support system for a TPS panel, according to some embodiments.

### DETAILED DESCRIPTION

This disclosure describes a system for supporting and connecting panels to an underlying structure. The system allows for a support structure to physically respond to thermal expansion or contraction of the panels, thus reducing thermally-induced stresses that may occur in the panels and the support structure itself. The system may be applied to spacecraft, for example, and panels or tiles of a thermal protection system (TPS) configured to protect the spacecraft during atmospheric reentries. In such an application, TPS panels are configured to absorb relatively large amounts of heat, leading to dramatic increases in their temperatures. The system described herein helps reduce or eliminate thermally-induced stresses in the TPS panels and connected components and structures that would otherwise result from their thermal expansion.

Although the embodiments described herein provide examples involving increasing temperatures and thermally expanding components, claimed subject matter may also encompass scenarios involving decreasing temperatures and the corresponding thermal contraction of components.

In some embodiments, a TPS may include a panel or tile, hinged stand-offs supporting a portion of the panel, and hinge attachments configured to i) be mounted on a vehicle to be thermally protected and ii) to support the hinged stand-offs without rotational resistance during thermal expansion of the panel. For example, a hinged stand-off may be a leg or rod having a hinge on one or both of its ends. Multiple hinged stand-offs may form a network or structure that supports multiple panels and mechanically connects them to the vehicle, which may (but need not) be a space vehicle.

In some implementations, a portion of a TPS may include a first TPS panel, a second TPS panel, a third TPS panel, a first hinged stand-off, a second hinged stand-off, and a third hinged stand-off. A first hinged stand-off may be connected to the first TPS panel, the second hinged stand-off may be connected to the second TPS panel, and the third hinged stand-off may be connected to the third TPS panel. The first, the second, and the third hinged stand-offs may, but need not, converge toward one another onto the vehicle. The TPS may further include a first hinge attachment, a second hinge attachment, and a third hinge attachment, all mounted on the vehicle. The three hinge attachments may be respectively configured to support the first, the second, and the third hinged stand-offs. The first, the second, and the third hinge attachments may each be part of a single (e.g., centralized) hinge unit mounted on the vehicle. The first, the second, and the third hinge attachments may all be mounted on the vehicle below a fourth TPS panel that separates the first, the second, and the third TPS panels from one another.

In some implementations, the first TPS panel, the second TPS panel, and the third TPS panel may have a perimeter that is hexagonal, square, rectangular, triangular, or various n-folded symmetric shapes (polygons), just to name a few examples. The number of stand-offs per panel may be different for different n-sided polygons. For example, three or six stand-offs per panel may be used for a 6-sided polygon (hexagon) and four or eight stand-offs per panel may be used for a square panel. Claimed subject matter is not limited in this respect.

In some embodiments, a first hinge attachment, which may be mounted to a vehicle, may be attached on one end of a hinged stand-off and a second hinge attachment, which may be mounted on a TPS panel, may be on the opposite end of the hinged stand-off. The second hinge attachment, like the first hinge attachment, may be configured to support the hinged stand-off without rotational resistance in a single plane during thermal expansion of the TPS panel.

In some embodiments, a support assembly for accommodating thermal expansion of a TPS panel may include a leg having a first end and a second end, a first attachment connecting the first end of the leg to the TPS panel, and a second attachment that is hinged and operatively connects the second end of the leg to a base structure. The hinged second attachment allows the leg to pivot and adjust its angular orientation in response to thermal expansion or contraction of the TPS panel, thereby mitigating stress accumulation in the TPS panel or the leg. The base structure may be an exterior surface of a space vehicle, for example. The leg may be the same as or similar to the hinged stand-off described above. The first attachment may be a rigid attachment connecting the first end of the leg to the TPS panel.

In some cases, the first attachment may be a first hinged attachment operatively connecting the first end of the leg to the TPS panel. The first hinged attachment may allow the leg to pivot and adjust its angular orientation in response to thermal expansion or contraction of the TPS panel, thereby mitigating stress accumulation in the TPS panel or the leg. The first and the second hinged attachments may be configured to operate in only one plane.

In some implementations, the TPS panel may be adjacent to a second TPS panel and the second hinged attachment may be underneath and directly below the second TPS panel.

In some embodiments, a TPS may include an arrangement of TPS panels and a system of hinged stand-offs supporting the TPS panels. The hinged stand-offs may be mounted on a vehicle to be thermally protected. The hinged stand-offs may be configured to support the TPS panels without rotational resistance during thermal expansion of the TPS panels. The hinged stand-offs may each comprise a first end and a second end, a first attachment connecting the first end of the hinged stand-off to one of the TPS panels, and a second attachment that is hinged and operatively connects the second end of the hinged stand-off to the vehicle. The hinged second attachment may allow the hinged stand-off to pivot and adjust its angular orientation in response to thermal expansion or contraction of the TPS panels, thereby mitigating stress accumulation in the TPS panels or the hinged stand-offs.

In some implementations, the first attachment may be a rigid attachment. In other implementations, the first attachment may be a first hinged attachment operatively connecting the first end of the hinged stand-off to one of the TPS panels. The first hinged attachment may allow the leg to pivot and adjust its angular orientation in response to thermal expansion or contraction of the TPS panels, thereby mitigating stress accumulation in the TPS panels or the hinged stand-offs. The first and the second hinged attachments may be configured to operate (e.g., rotate) in only one plane.

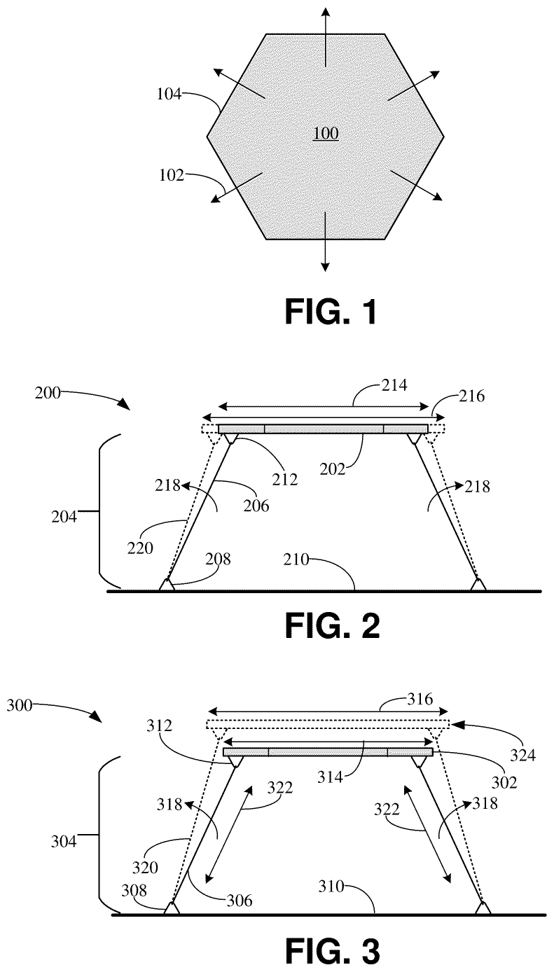

FIG. 1 is a top view of a TPS panel 100, according to some embodiments. Panel 100 may also be named or described as a tile, plate, shield, pad, sheet, and so on. Panel 100 may be, for example, a thermal protection component configured to shield specific areas of a spacecraft from extreme temperatures during high-speed atmospheric entry or other heat-intensive operations. Panel 100 may be positioned over the exterior surface of the craft, forming part of an array or layer that collectively serves as a barrier against heat transfer. Its purpose is to absorb, reflect, and/or dissipate thermal energy, thereby protecting the underlying structure. Accordingly, panel 100 may be one of many panels, a portion of which may be adjacent to panel 100.

During operation, as the temperature of panel 100 increases substantially, it undergoes thermal expansion so that its physical dimensions (length, width, and possibly thickness) increase, as indicated by arrows 102. The extent of the thermal expansion depends on the coefficient of thermal expansion (CTE) of the panel's material and the temperature rise. If panel 100 is rigidly attached or confined, expansion may generate thermally-induced loads or stresses that could lead to cracking, buckling, or delamination, for example, particularly in high-stress areas or where multiple tiles meet. As described herein, an attachment system can accommodate thermal expansion to prevent damage to panel 100, its neighbors, and the underlying support structure.

Panel 100, described as one of many similar panels, may be designed to have a hexagonal perimeter 104 to enable a close-packing arrangement. This configuration is particularly advantageous for thermal protection systems, as it allows for the panels to be arranged together without leaving any gaps, except for intentional spacings that may be present to accommodate the panels' dimensional changes with temperature. Hexagons tessellate perfectly, meaning they can cover a flat surface completely without overlaps or voids, unlike circular or irregularly shaped panels. Shapes other than hexagons, such as squares and triangles, can also tessellate. However, a hexagonal geometry may provide a number of benefits over other shapes, such as higher efficiency in material usage and a relatively more uniform stress distribution. Also, hexagons adapt more easily to gentle curved surface as compared to the shape adaptability of squares or triangles. Nevertheless, claimed subject matter is not limited to hexagonally-shaped panels.

FIG. 2 is a side view of a thermal protection system 200 that includes a panel 202 and an underlying support system 204 during thermal expansion of the panel, according to some embodiments. Panel 202 may be the same as or similar to panel 100. Support system 204 may include a hinged stand-off 206 supporting a portion of panel 202, a first hinge attachment 208 mounted on a vehicle 210 to be thermally protected, and a second hinge attachment 212 mounted to panel 202. Sizes and relative dimensions of elements of system 200 are not necessarily illustrated to scale. For example, claimed subject matter is not limited in the shape, height, and number of stand-offs in a system such as 200.

Multiple hinged stand-offs 206 may form a network or structure of support system 204 to support multiple panels 202 and to mechanically connect the panels to vehicle 210. First hinge attachment 208 connects a first end of hinged stand-off 206 to vehicle 210 and second hinge attachment 212 connects a second end of hinged stand-off 206 to panel 202.

In the illustrated example embodiment, panel 202 has a width 214 (e.g., as measured along its largest dimension) that may increase to a new larger width 216 as its temperature increases. As the width of panel 202 increases, hinged stand-offs 206 rotate, as indicated by arrows 218, to a new position 220. Note that positional changes due to temperature changes are generally exaggerated herein in the figures for clarity. First and second hinge attachments 208 and 212 allow this rotation by supporting hinged stand-off 206 without rotational resistance during thermal expansion of panel 202. In particular, the hinge attachments may provide the hinged stand-off 206 the ability to freely rotate about axes of the hinge attachments. In some implementations, such a free rotation may be limited to a single plane. The rotational degree of freedom offered by first hinge attachment 208 and/or second hinge attachment 212 may mitigate thermally-induced stresses on various parts of system 200, such as panels 202 and hinged stand-offs 206, for example.

FIG. 3 is a side view of a thermal protection system 300 that includes a panel 302 and an underlying support system 304 during thermal expansion of the panel and the support system, according to some embodiments. Panel 302 may be the same as or similar to panel 202 and support system 304 may be the same as or similar to support system 204 except that thermal expansion of hinged stand-offs 306 are considered in these embodiments. In some implementations, however, a support system (e.g., 204) may include hinged standoffs that have lengths that are equal to one another so that their thermal expansion or contraction may likely add little or no thermally-induced stress on the overlying panels.

Support system 304 may include hinged stand-offs 306 supporting a portion of panel 302, a first hinge attachment 308 mounted on a vehicle 310 to be thermally protected, and a second hinge attachment 312 mounted to panel 302. Multiple hinged stand-offs 306 may form a network or structure of support system 304 to support multiple panels 302 and to mechanically connect the panels to vehicle 310. First hinge attachment 308 connects a first end of hinged stand-off 306 to vehicle 310 and second hinge attachment 312 connects a second end of hinged stand-off 306 to panel 302. Sizes and relative dimensions of elements of system 300 are not necessarily illustrated to scale.

In the illustrated example embodiment, panel 302 has a width 314 (e.g., as measured along its largest dimension) that may increase to a new larger width 316 as its temperature increases. As the width of panel 302 increases, hinged stand-offs 306 rotate, as indicated by arrows 318, to a new position 320. First and second hinge attachments 308 and 312 allow this rotation by supporting hinged stand-off 306 without rotational resistance during thermal expansion of panel 302. Additionally, hinged stand-offs 306 may also thermally expand in a general direction indicated by arrows 322. This length expansion may lead to panel 302 occupying a new position 324 (exaggerated for clarity). Also, this length expansion and the increasing width of panel 302 may contribute to hinged stand-offs 306 occupying new position 320. The rotational degree of freedom offered by first hinge attachment 308 and/or second hinge attachment 312 may mitigate thermally-induced stresses on various parts of system 300, such as panels 302 and hinged stand-offs 306, for example.

In some implementations, the stand-off or hinge attachments may include stops/pins to limit the extent of rotation of the stand-offs. For example, an expected maximum rotation angle of the stand-offs may be only several degrees. Thus, the rotational coupling between the stand-offs and the hinge attachments may be configured for rotations of less than a few degrees, though claimed subject matter is not so limited.

In some implementations, the hinge attachments may be configured to provide some thermal isolation between the vehicle and the stand-offs. For example, thermal conductive paths in the hinge attachments may have a relatively high heat flow resistance due to the geometry of the hinge attachment components (e.g., the pin, hinge knuckle, and hinge plates, etc.).

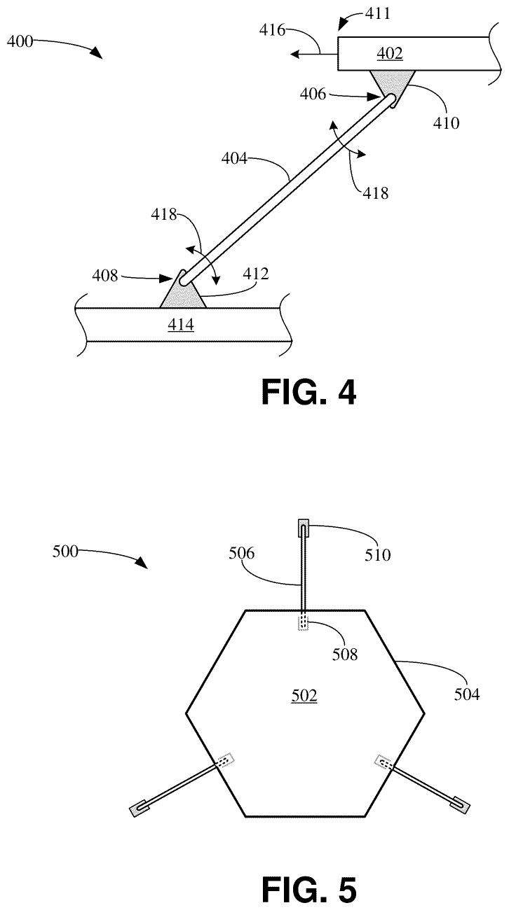

FIG. 4 is a close-up side view of a portion 400 of a support system for a TPS panel 402, according to some embodiments. Panel 402 may be the same as or similar to panels 202 or 302 and the support system may be the same as or similar to support system 204 or 304. A hinged stand-off 404 has a first end 406 and a second end 408. First end 406 of hinged stand-off 404 may be connected to panel 402 via a first hinge attachment 410, which may be at or near an edge 411 of panel 402. Second end 408 of hinged stand-off 404 may be connected via a second hinge attachment 412 to a vehicle 414 that is to be thermally protected, for example.

Generally, as panel 402 absorbs heat it will expand, as indicated by arrow 416. As this occurs, first hinge attachment 410 and second hinge attachment 412 may allow hinged stand-off 404 to rotate, as indicated by arrows 418 (double-ended arrows are used to indicate a rotational degree of freedom in both directions, e.g., for thermal expansion and thermal contraction of panel 402). In contrast, in the case where panel 402 is rigidly connected to vehicle 414 via a rigidly fastened stand-off, instead of hinged stand-off 404, thermal expansion of panel 402 may i) lead to the panel applying a bending force (e.g., torque) on the rigidly fastened stand-off and, in response, ii) the rigidly fastened stand-off applying a compressive force on the panel. The use of hinge attachments (e.g., first hinge attachment 410 and second hinge attachment 412) may eliminate or at least reduce these forces, which give rise to stresses that can damage a thermal protection system.

FIG. 5 is a top view of a portion of a thermal protection system 500 that includes a TPS panel 502 and an underlying support system, according to some embodiments. Panel 502 may have an hexagonal perimeter or edge 504, though claimed subject matter is not limited to such a shape. Components of system 500 may be the same as or similar to their respective corresponding components in systems 200 or 300, for example. The support system includes hinged stand-offs 506, first hinge attachments 508 and second hinge attachments 510. As described below, panel 502 is one of a plurality of such panels, which may be arranged contiguously (e.g., edge to edge) with one another. The hexagonal shape, for instance, enables efficient packing of the panels without creating geometric gaps. In comparison, shapes like circles inherently leave gaps when arranged together.

Also described below, second hinge attachments 510 may be underneath and directly below at least some of the panels that are adjacent to panel 502. Also, second hinge attachments 510 may be attached to a vehicle such as 210, 310, or 414, just to name a few examples. First hinge attachments 508, which are partially visible through panel 502 in the figure, may be located at or near edge 504, which may be the same as or similar to edge 411 mentioned above.

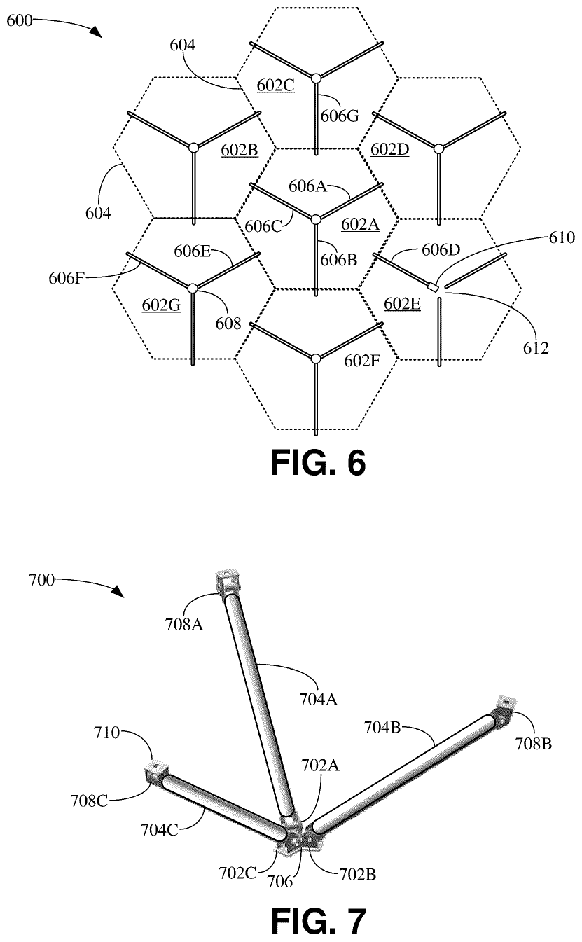

FIG. 6 is a top view of a portion of a thermal protection system 600 that includes a group of TPS panels 602 and an underlying support system for the TPS panels, according to some embodiments. The group of panels 602 includes panels 602A, 602B, 602C, 602D, 602E, 602F, and 602G. In this group, panel 602A is centrally positioned, with the other panels placed contiguously around it. In some implementations, there may be small gaps between edges 604 of neighboring panels to allow for thermal expansion and/or engineering tolerances, for example.

The support system includes hinged stand-offs 606, some of which are labelled 606A, 606B, 606C, 606D, 606E, 606F, and 606G. Although not explicitly illustrated in the figure, each of the hinged stand-offs may be connected to respective panels 602, as illustrated in FIG. 4, though their connection to the panels need not be a hinged connection, as explained below. Instead, the only hinge connection for each hinged stand-off may be their respective connection to the vehicle for which system 600 is to thermally protect. Accordingly, each of hinged stand-offs 606 may be attached, hingedly or rigidly, to respective panels 602 at or near their edges 604. Claimed subject matter, however, is not limited to where stand-offs are connected (via hinge attachment) to the panels. For example, the connections may be along any part of the panels' perimeter (e.g., edge 604), not just at the center of a side, as illustrated.

In some implementations, for example, hinged stand-off 606A may be connected to the panel 602D, hinged stand-off 606B may be connected to panel 602F, and hinged stand-off 606C may be connected to panel 602B. Hinged stand-offs 606A, 606B, and 606C may, but need not, converge toward (but not necessarily meet) one another onto the vehicle at a point or small area below, and at least approximately centrally located, panel 602A. At this point or small area, for example, hinge attachments mounted on the vehicle may connect to respective hinged stand-offs 606A, 606B, and 606C. In such an arrangement, alternating neighboring panels (602B, 602D, and 602F) of panel 602A are partially supported by hinged stand-offs that converge under panel 602A. Meanwhile, the other alternating neighboring panels (602C, 602E, and 602G) are supported by hinged stand-offs that are not converging below panel 602A.

In some implementations, hinge attachments that receive converging hinged stand-offs (e.g., 606A, 606B, and 606C) may each be part of a single (e.g., centralized) hinge unit 608 mounted on the vehicle. In other implementations, of which one example is illustrated in the figure, hinge attachments that receive converging hinged stand-offs (e.g., 606A, 606B, and 606C) may include one hinge attachment 610 per one hinged stand-off (e.g., 606D) at or near a central point 612 under a panel (e.g., panel 602E).

FIG. 7 is a perspective view of a portion 700 of a support system for TPS panels, according to some embodiments. Portion 700 includes hinge attachments 702A, 702B, and 702C that respectively receive converging hinged stand-offs 704A, 704B, and 704C. In some embodiments, hinge attachments 702A, 702B, and 702C may each be part of a single (e.g., centralized) hinge unit 706 mounted on a vehicle, for example. Thus, hinge unit 706 may be similar to or the same as hinge unit 608 In other implementations, hinge attachments that receive converging hinged stand-offs 704A, 704B, and 704C may include one hinge attachment attached to the vehicle per one hinged stand-off. In this case, hinged stand-off 704A includes hinge attachment 702A, hinged stand-off 704B includes hinge attachment 702B, and hinged stand-off 704C includes hinge attachment 702C.

Hinge attachments 708 may also be on ends of the hinged stand-offs that are opposite the ends at or near the vehicle. These hinge attachments may be connected to a panel, such as TPS panels 602. For example, hinged stand-off 704A may include a hinge attachment 708A, hinged stand-off 704B may include a hinge attachment 708B, and hinged stand-off 704C may include a hinge attachment 708C. A top surface 710 of the hinge attachments may be configured to mate and attach to a panel.

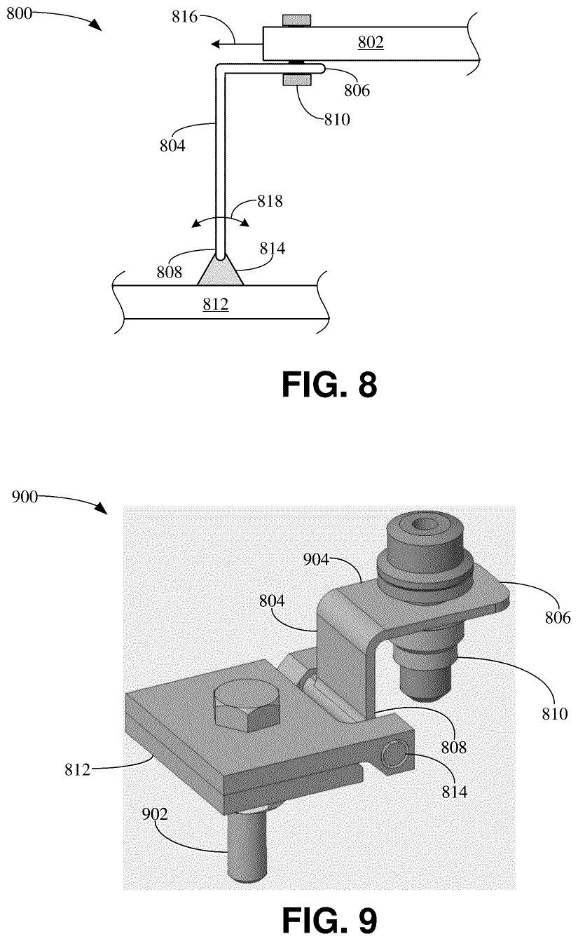

FIG. 8 is a close-up side view of a portion of a thermal protection system 800 that includes a support system for a panel 802, according to some embodiments that differ from earlier embodiments in that hinged stand-offs include a single hinge. In particular, the support system includes hinged stand-offs 804 having a first end 806 and a second end 808 opposite the first end. First end 806 may be rigidly attached via rigid attachment 810 to panel 802 and second end 808 may be hingedly attached to a vehicle 812, for example, via a hinge attachment 814. This is different from earlier embodiments wherein both ends of hinged stand-offs include hinged attachments.

Generally, as panel 802 absorbs heat it will expand, as indicated by arrow 816. As this occurs, hinge attachment 814 may allow hinged stand-off 804 to rotate, as indicated by arrow 818 (a double-ended arrow is used to indicate a rotational degree of freedom in both directions, e.g., for thermal expansion and thermal contraction of panel 802). Because a rotational degree of freedom is only provided at second end 808 and first end 806 involves a rigid attachment to panel 802, thermal expansion of panel 802 may lead to i) the panel applying a bending force (e.g., torque) on (semi) hinged stand-off 804 and, in response, ii) hinged stand-off 804 applying a compressive force on the panel. The use of a hinge attachments on only one end of hinged stand-offs may be less effective at reducing or eliminating material stresses as compared to use of hinge attachment on both ends of hinged stand-offs, but the former approach may be easier and less expensive to construct while still providing an effective solution to reducing stresses that can damage a thermal protection system.

FIG. 9 is a close-up perspective view of a portion of a support system 900 for a TPS panel, according to some embodiments. As in all figures herein, dimensions and proportions are not necessarily to scale. Support system 900 may be described with respect to elements of the support system for thermal protection system 800. Accordingly, the portion of support system 900 includes hinged stand-off 804 having a first end 806 and a second end 808 opposite the first end. First end 806 may be rigidly attached via rigid attachment 810 to panel 802, which is not illustrated in FIG. 9. Second end 808 may be hingedly attached to a vehicle 812, for example, via a hinge attachment 814. In some implementations, a mechanical fastener 902 may be used to connect hinge attachment 814 to vehicle 812. In other implementations, welding may be used to connect hinge attachment 814 to vehicle 812. Rigid attachment 810 may be located in a portion 904 of hinged stand-off 804 that is generally parallel to the panel.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

1. A thermal protection system (TPS) comprising:
a TPS panel;
a hinged stand-off supporting a portion of the TPS panel; and
a hinge attachment configured to i) be mounted on a vehicle to be thermally protected and ii) to pivotally support the hinged stand-off for rotation about a hinge axis confined to a single plane during thermal expansion of the TPS panel.

2. The system of claim 1, wherein the TPS panel is a first TPS panel and the hinged stand-off is a first hinged stand-off, and further comprising:
a second TPS panel and a third TPS panel; and
a second hinged stand-off and a third hinged stand-off, wherein the first hinged stand-off is connected to the first TPS panel, the second hinged stand-off is connected to the second TPS panel, and the third hinged stand-off is connected to the third TPS panel, and wherein the first, the second, and the third hinged stand-offs converge toward one another onto the vehicle.

3. The system of claim 2, wherein the hinge attachment is a first hinge attachment, and further comprising a second hinge attachment mounted on the vehicle and a third hinge attachment mounted on the vehicle, respectively configured to support the second hinged stand-off and the third hinged stand-off.

4. The system of claim 3, wherein the first, the second, and the third hinge attachments are each part of a single hinge unit mounted on the vehicle.

5. The system of claim 3, wherein the first, the second, and the third hinge attachments are all mounted on the vehicle below a fourth TPS panel that separates the first, the second, and the third TPS panels from one another.

6. The system of claim 2, wherein the first TPS panel, the second TPS panel, and the third TPS panel have an hexagonal perimeter.

7. The system of claim 1, wherein the hinge attachment is a first hinge attachment, and further comprising a second hinge attachment mounted on the TPS panel, wherein the second hinge attachment is configured to pivotally support the hinged stand-off for rotation about a hinge axis confined to the single plane during the thermal expansion of the TPS panel.

8. The system of claim 7, wherein the first hinge attachment is connected to a first end of the hinged stand-off and the second hinge attachment is connected to a second end, opposite the first end, of the hinged stand-off.

9. A support assembly for accommodating thermal expansion of a thermal protection system (TPS) panel, the support assembly comprising:
a leg having a first end and a second end;
a first attachment connecting the first end of the leg to the TPS panel; and
a second attachment that is hinged and operatively connects the second end of the leg to a base structure,
wherein the hinged second attachment pivotally supports the leg for rotation about a hinge axis confined to a single plane in response to thermal expansion or contraction of the TPS panel, thereby mitigating stress accumulation in the TPS panel or the leg.

10. The support assembly of claim 9, wherein the first attachment is a rigid attachment connecting the first end of the leg to the TPS panel.

11. The support assembly of claim 9, wherein the first attachment is a first hinged attachment operatively connecting the first end of the leg to the TPS panel, and wherein the first hinged attachment allows the leg to pivot and adjust its angular orientation in response to thermal expansion or contraction of the TPS panel, thereby mitigating stress accumulation in the TPS panel or the leg.

12. The support assembly of claim 11, wherein the first and the second hinged attachments are configured to operate for rotation about respective hinge axes confined to the single plane.

13. The support assembly of claim 9, wherein the base structure is a vehicle configured for atmospheric reentry.

14. The support assembly of claim 9, wherein the TPS panel is a first TPS panel that is adjacent to a second TPS panel, wherein the second hinged attachment is underneath and directly below the second TPS panel.

15. The support assembly of claim 14, wherein the first TPS panel and the second TPS panel have an hexagonal perimeter.

16. A thermal protection system (TPS) comprising:
an arrangement of TPS panels; and
a system of hinged stand-offs supporting the TPS panels, the hinged stand-offs mounted on a vehicle to be thermally protected, wherein the hinged stand-offs are pivotally supported for rotation about respective hinge axes confined to a single plane during thermal expansion of the TPS panels.

17. The TPS of claim 16, wherein the hinged stand-offs each comprise:
a first end and a second end;
a first attachment connecting the first end of the hinged stand-off to one of the TPS panels; and
a second attachment that is hinged and operatively connects the second end of the hinged stand-off to the vehicle,
wherein the hinged second attachment allows the hinged stand-off to pivot and adjust its angular orientation in response to thermal expansion or contraction of the TPS panels, thereby mitigating stress accumulation in the TPS panels or the hinged stand-offs.

18. The TPS of claim 17, wherein the first attachment is a rigid attachment.

19. The TPS of claim 17, wherein the first attachment is a first hinged attachment operatively connecting the first end of the hinged stand-off to the one of the TPS panels, and wherein the first hinged attachment allows the hinged stand-off off to pivot and adjust its angular orientation in response to thermal expansion or contraction of the TPS panels, thereby mitigating stress accumulation in the TPS panels or the hinged stand-offs.

20. The TPS of claim 19, wherein the first and the second hinged attachments are configured to operate for rotation about respective hinge axes confined to the single plane.
